(19) United States
(12) Patent Application Publication
(10) Pub. No.: US 2017/0196025 A1
(43) Pub. Date: Jul. 6, 2017

(54) Random Access Probing Enhancement During State Mismatch Between User Equipment And Network

(71) Applicant: MediaTek Inc., Hsinchu City (TW)

(72) Inventors: Shih-Hsin Chien, New Taipei City (TW); Chi-Chen Lee, Taipei City (TW)

(21) Appl. No.: 15/465,833

(22) Filed: Mar. 22, 2017

Related U.S. Application Data
(60) Provisional application No. 62/311,948, filed on Mar. 23, 2016.

(51) Int. Cl. H04W 74/08; H04W 68/02; H04W 72/04

(52) U.S. Cl. CPC H04W 74/0833; H04W 72/04; H04W 68/02

(57) ABSTRACT

Methods and apparatuses pertaining to random access probing enhancement during state mismatch between a communication apparatus and a network apparatus may involve the communication apparatus determining whether a state mismatch exists between the communication apparatus and a network apparatus. The communication apparatus may also conduct a probing procedure responsive to a determination that the state mismatch exists. The network apparatus may transmit a value representative of a timer duration to the communication apparatus. The network apparatus may also participate in the probing procedure with the communication apparatus.

### CROSS REFERENCE TO RELATED PATENT APPLICATION(S)

The present disclosure is part of a non-provisional application claiming the priority benefit of U.S. Patent Application No. 62/311,948, filed on 23 Mar. 2016, which is incorporated by reference in its entirety.

### TECHNICAL FIELD

The present disclosure is generally related to telecommunications and, more particularly, to enhancement in wireless communications between mobile terminals and networks.

### BACKGROUND

Unless otherwise indicated herein, approaches described in this section are not prior art to the claims listed below and are not admitted to be prior art by inclusion in this section.

There are various well-developed and well-defined cellular communications technologies in telecommunications that enable wireless communications using mobile terminals, or user equipment (UE). For example, the Global System for Mobile communications (GSM) is a well-defined and commonly used communications system, which uses time division multiple access (TDMA) technology, which is a multiplex access scheme for digital radio, to send voice, video, data, and signaling information (such as a dialed telephone number) between mobile phones and cell sites. The CDMA2000 is a hybrid mobile communications 2.5G/3G (generation) technology standard that uses code division multiple access (CDMA) technology. The UMTS (Universal Mobile Telecommunications System) is a 3G mobile communications system, which provides an enhanced range of multimedia services over the GSM system. The Long-Term Evolution (LTE), as well as its derivatives such as LTE-Advanced and LTE-Advanced Pro, is a standard for high-speed wireless communication for mobile phones and data terminals.

At times, there may be mismatch between a UE and a network and, in certain cases, there is no solution defined in the pertinent standard and/or specification(s). For example, referring to FIG. 9, a network node (e.g., eNodeB in a LTE network) may have data to be transmitted to a UE and thus may inform the UE, by a Physical Downlink Control Channel (PDCCH) order, that there is downlink (DL) data for the UE. As the UE may be idle for a while prior to receiving such notice, the UE may request for resources from the network node by sending a Random Access (RA) request to the network node, and the network node may reply with a RA response (RAR). Subsequently, the UE may acknowledge the receipt of the RAR by sending a Physical Uplink Shared Channel (PUSCH) acknowledgement to the network node, which may be lost or otherwise not received by the network node. As a result, while the UE may wait for the DL data from the network node, the network node may continue to wait for an acknowledgement from the UE. The network node may transmit the PDCCH order to UE.

After not receiving the acknowledgement from the UE for a period of time, the network node may consider the UE being out of service (00S) and may release UE context, in addition to switching the state of the UE to Radio Resource Control (RRC) idle. On the other hand, not aware of the problem, the UE may stay in a connected mode as the channel condition may not have deteriorated to a condition for the UE to consider that there is a radio link failure. However, as the UE stays in the connected mode, power consumption at the UE would be unnecessarily higher than if the UE switches to an idle mode. Moreover, it is not yet defined in the 3^{rd} Generation Partnership Project (3GPP) on how the UE can handle paging when the state between the UE and the network node is asynchronous (e.g., when there is mismatch in the communications between the UE and the network node).

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues with respect an asynchronous state in which there is communication mismatch between a UE and a network node.

In one aspect, a method may involve a communication apparatus determining whether a state mismatch exists between the communication apparatus and a network apparatus. The method may also involve the communication apparatus conducting a probing procedure responsive to a determination that the state mismatch exists.

In another aspect, a method may involve a network apparatus transmitting a value representative of a timer duration to a communication apparatus. The method may also involve the network apparatus participating in a probing procedure with the communication apparatus responsive to either of: (1) receiving a random access (RA) preamble from the communication apparatus; or (2) determining that there is data or a mobile-terminated call for the communication apparatus.

In one aspect, a communication apparatus may include a transceiver capable of wirelessly communicating with a network apparatus. The communication apparatus may also include a processor. The processor may be capable of determining whether a state mismatch exists between the communication apparatus and the network apparatus. The processor may be also capable of conducting a probing procedure responsive to a determination that the state mismatch exists.

In another aspect, a network apparatus may include a transceiver capable of wirelessly communicating with a communication apparatus. The communication apparatus may also include a processor. The processor may be capable of transmitting, via the transceiver, a value representative of a timer duration to a communication apparatus. The processor may be also capable of participating in a probing procedure with the communication apparatus.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a block diagram of an example communication apparatus and an example network apparatus in accordance with an implementation of the present disclosure.

FIG. 7 is a flowchart of an example process in accordance with an implementation of the present disclosure.

FIG. 8 is a flowchart of an example process in accordance with an implementation of the present disclosure.

FIG. 9 is a diagram depicting a state mismatch between a UE and a network node under conventional approaches.

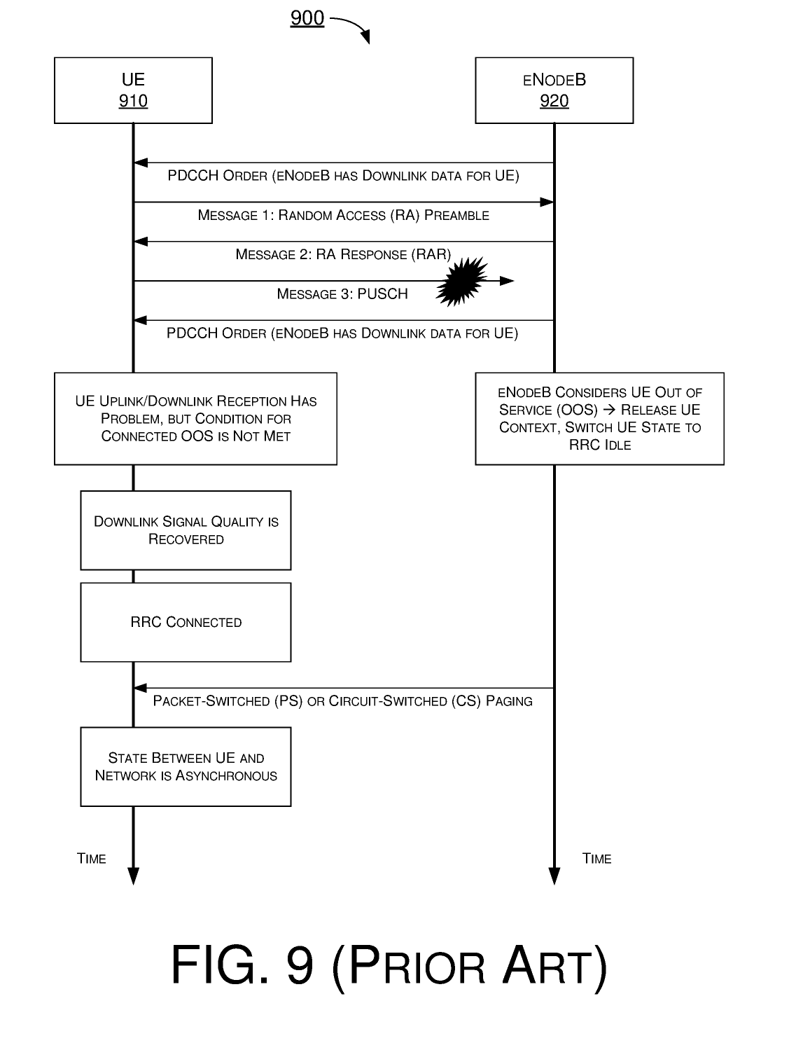

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

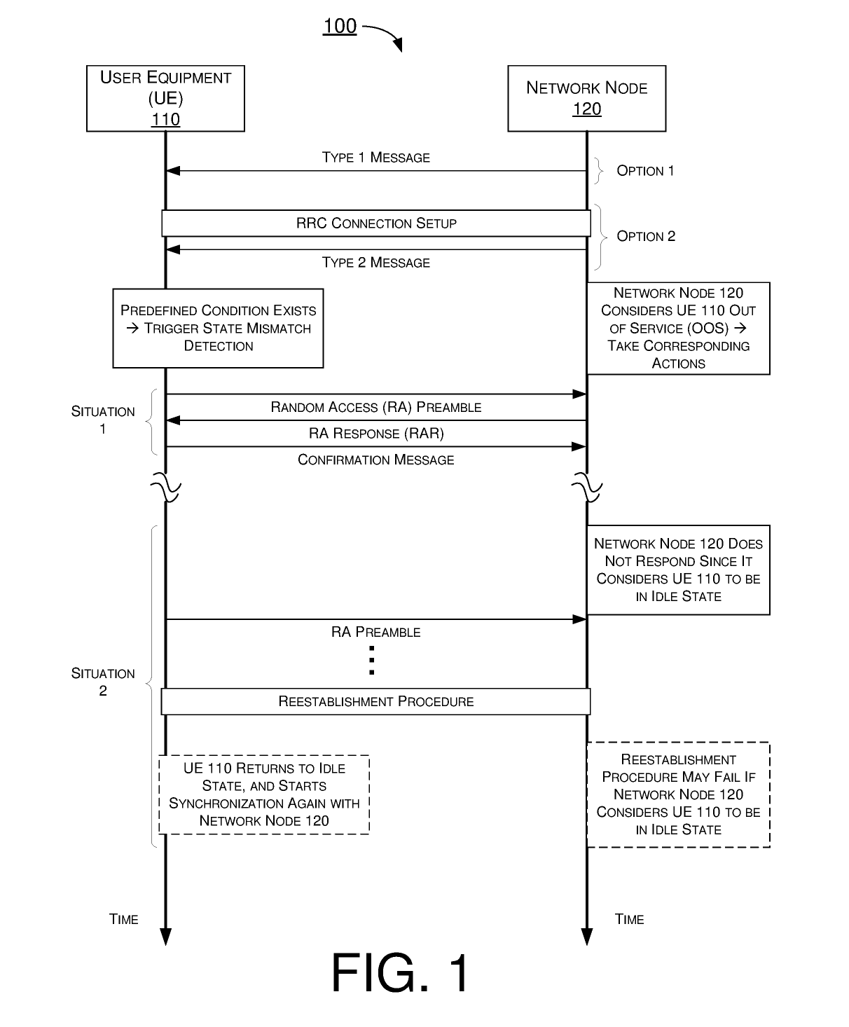

FIG. 1 illustrates an example scenario 100 under schemes in accordance with implementations of the present disclosure. Scenario 100 involves a UE 110 and a network node 120, which may be part of a wireless network (e.g., a LTE network, a LTE-Advanced network or a LTE-Advanced Pro network). The network, via network node 120, may provide UE 110 a configurable timer to detect whether UE 110 may be out of synchronization (out-of-sync) with the network. As shown in FIG. 1, in a first option (option 1), a first value (e.g., Tstate_async_detect) representative of a duration of a detection timer may be transmitted from network node 120 to UE 110 via a first type of message (type 1 message). The type 1 message may be broadcast in system information via, for example, a broadcast message transmitted to all UE's in communication with network node 120, including UE 110. Also shown in FIG. 1, in a second option (option 2), the first value representative of the duration of the detection timer may be transmitted from network node 120 to UE 110 via a second type of message (type 2 message). To transmit the first value to UE 110, network node 120 may set up a Radio Resource Control (RRC) connection with UE 110 and transmit the type 2 message which may be, for example, a dedicated signaling specific or otherwise dedicated for UE 110 (and optionally one or more other UE's). Either or both of option 1 and option 2 may be utilized.

At the UE end, in an event that a predefined condition exists, UE 110 may trigger a state mismatch detection to detect and determine whether there is a state mismatch between UE 110 and the network (as represented by network node 120). The predefined condition may include, for example, (1) UE 110 has no downlink (DL) user data, uplink (UL) user data or signaling data for more than the duration of the detection timer, as represented by the first value; and (2) UE 110 is in a connected mode and that RRC connection is not released. At the network end, having not received any communication from UE 110, network node 120 may consider UE 110 to be out of service (00S). Consequently, network node 120 may release UE context for UE 110 and may also switch UE state of UE 110 to RRC idle.

As part of the state mismatch detection, UE 110 may transmit a random access (RA) preamble (e.g., message 1) to network node 120. Upon receiving the RA preamble from UE 110, network node 120 may transmit a RA response (RAR) to UE 110. Upon receiving the RAR from network node 120, UE 110 may transmit a confirmation message to network node 120 to indicate that UE 110 is in a connected mode. The message may be, for example, a UE Cell Radio Network Temporary Identifier (C-RNTI) Media Access Control (MAC) Control Element (CE) or a UE state synchronized message. The above pertains to the portion labeled as “situation 1” in FIG. 1.

In an event that no RAR has been received from network node 120 after UE 110 has transmitted a number of RA preambles to network node 120 (e.g., up to a threshold number of times), UE 110 may conduct or otherwise initiate a reestablishment procedure in response to not receiving any RAR from network node 120 after transmitting a number of RA preambles to network node 120. Upon successful reestablishment, UE 110 and network node 120 may be considered to be in synch in connected mode. However, as indicated in dotted-lined blocks, the reestablishment procedure may fail in an event that network node 120 continues to consider UE 110 to be in an idle state and thus may not respond to RA preambles from UE 110. In such cases UE 110 may return to idle state and may start synchronization again with network node 120. The above pertains to the portion labeled as “situation 2” in FIG. 1.

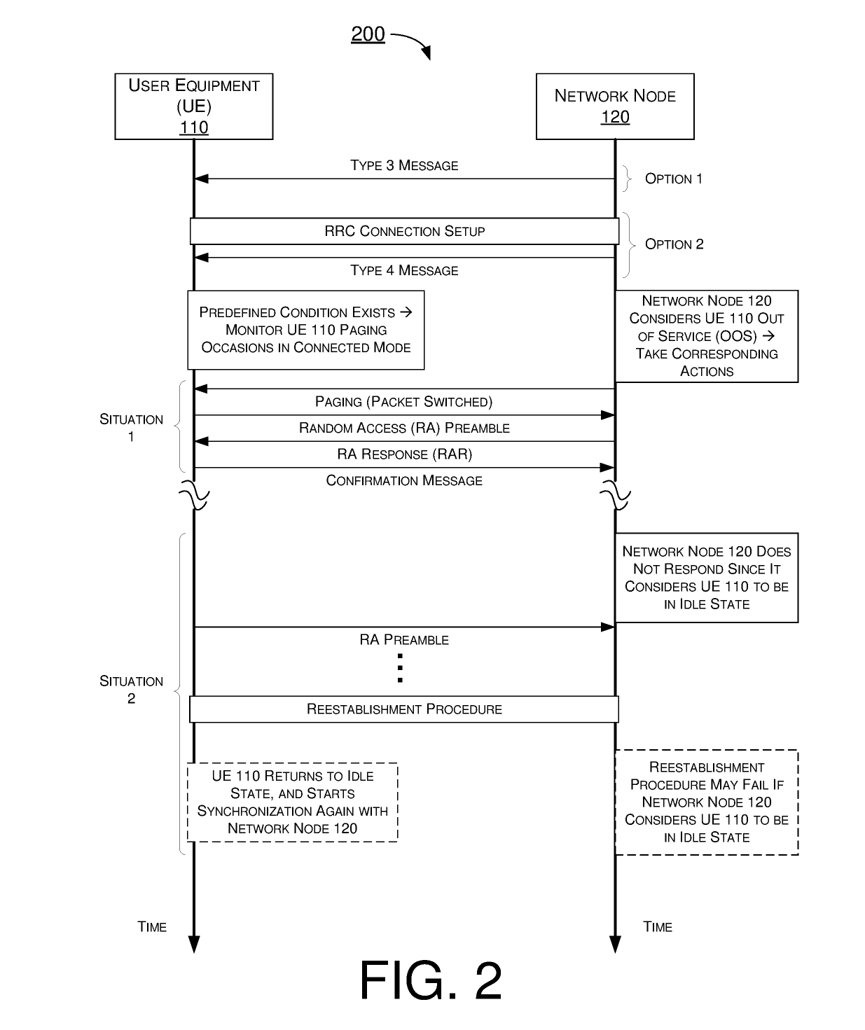

FIG. 2 illustrates an example scenario 200 under schemes in accordance with implementations of the present disclosure. Scenario 200 involves a UE 110 and a network node 120, which may be part of a wireless network (e.g., a LTE network, a LTE-Advanced network or a LTE-Advanced Pro network). The network, via network node 120, may provide UE 110 a configurable timer to detect whether UE 110 may be out of synchronization (out-of-sync) with the network. As shown in FIG. 2, in a first option (option 1), a second value (e.g., Tstate_async_paging) representative of a duration of a paging timer may be transmitted from network node 120 to UE 110 via a third type of message (type 3 message). The type 3 message may be broadcast in system information via, for example, a broadcast message transmitted to all UE's in communication with network node 120, including UE 110. Also shown in FIG. 2, in a second option (option 2), the second value representative of the duration of the paging timer may be transmitted from network node 120 to UE 110 via a fourth type of message (type 4 message). To transmit the second value to UE 110, network node 120 may set up a Radio Resource Control (RRC) connection with UE 110 and transmit the type 4 message which may be, for example, a dedicated signaling specific or otherwise dedicated for UE 110 (and optionally one or more other UE's). Either or both of option 1 and option 2 may be utilized.

At the UE end, in an event that a predefined condition exists, UE 110 may monitor UE paging occasions with UE 110 in RRC connected mode to detect and determine whether there is a state mismatch between UE 110 and the network (as represented by network node 120). The predefined condition may include, for example, (1) UE 110 has no DL user data, UL user data or signaling data for more than the duration of the timer, as represented by the first value; and (2) UE 110 is in a connected mode and that RRC connection is not released. At the network end, having not received any communication from UE 110, network node 120 may consider UE 110 to be out of service (00S). Consequently, network node 120 may release UE context for UE 110 and may also switch UE state of UE 110 to RRC idle.

As part of the monitoring of UE paging occasions, UE may receive paging from network node 120. The paging from network node 120 may be, for example, in packet-switched (PS) domain, and UE 110 may be identified by a SAE Temporary Mobile Subscriber Identity (S-TMSI) or International Mobile Subscriber Identity (IMSI). UE 110 may transmit a RA preamble (e.g., message 1) to network node 120. Upon receiving the RA preamble from UE 110, network node 120 may transmit a RAR to UE 110. Upon receiving the RAR from network node 120, UE 110 may transmit a confirmation message to network node 120 to indicate that UE 110 is in a connected mode. The message may be, for example, a UE C-RNTI MAC CE or a UE state synchronized message. The above pertains to the portion labeled as “situation 1” in FIG. 2.

In an event that no RAR has been received from network node 120 after UE 110 has transmitted a number of RA preambles to network node 120 (e.g., up to a threshold number of times), UE 110 may conduct or otherwise initiate a reestablishment procedure in response to not receiving any RAR from network node 120 after transmitting a number of RA preambles to network node 120. Upon successful reestablishment, UE 110 and network node 120 may be considered to be in synch in connected mode. However, as indicated in dotted-lined blocks, the reestablishment procedure may fail in an event that network node 120 continues to consider UE 110 to be in an idle state and thus may not respond to RA preambles from UE 110. In such cases UE 110 may return to idle state and may start synchronization again with network node 120. The above pertains to the portion labeled as “situation 2” in FIG. 2.

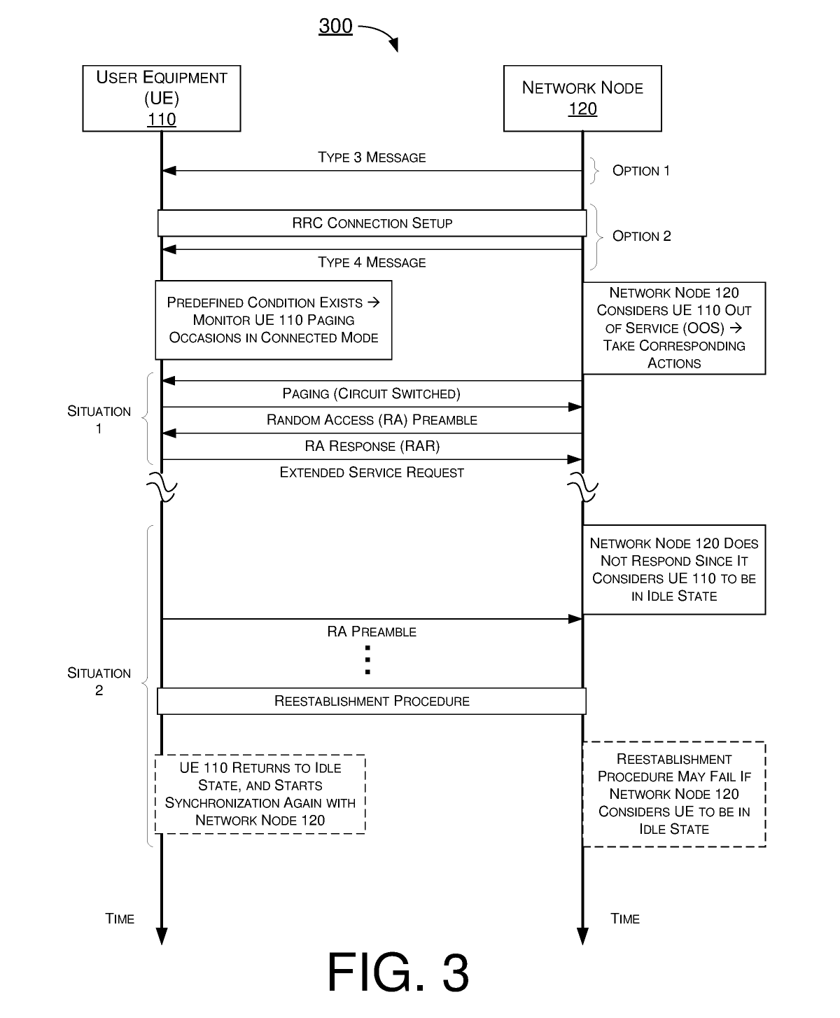

FIG. 3 illustrates an example scenario 300 under schemes in accordance with implementations of the present disclosure. Scenario 300 involves a UE 110 and a network node 120, which may be part of a wireless network (e.g., a LTE network, a LTE-Advanced network or a LTE-Advanced Pro network). The network, via network node 120, may provide UE 110 a configurable timer to detect whether UE 110 may be out of synchronization (out-of-sync) with the network. As shown in FIG. 3, in a first option (option 1), a second value (e.g., Tstate_async_paging) representative of a duration of a paging timer may be transmitted from network node 120 to UE 110 via a third type of message (type 3 message). The type 3 message may be broadcast in system information via, for example, a broadcast message transmitted to all UE's in communication with network node 120, including UE 110. Also shown in FIG. 3, in a second option (option 2), the second value representative of the duration of the paging timer may be transmitted from network node 120 to UE 110 via a fourth type of message (type 4 message). To transmit the second value to UE 110, network node 120 may set up a Radio Resource Control (RRC) connection with UE 110 and transmit the type 4 message which may be, for example, a dedicated signaling specific or otherwise dedicated for UE 110 (and optionally one or more other UE's). Either or both of option 1 and option 2 may be utilized.

At the UE end, in an event that a predefined condition exists, UE 110 may monitor UE paging occasions with UE 110 in RRC connected mode to detect and determine whether there is a state mismatch between UE 110 and the network (as represented by network node 120). The predefined condition may include, for example, (1) UE 110 has no DL user data, UL user data or signaling data for more than the duration of the timer, as represented by the first value; and (2) UE 110 is in a connected mode and that RRC connection is not released. At the network end, having not received any communication from UE 110, network node 120 may consider UE 110 to be out of service (00S). Consequently, network node 120 may release UE context for UE 110 and may also switch UE state of UE 110 to RRC idle.

As part of the monitoring of UE paging occasions, UE may receive paging from network node 120. The paging from network node 120 may be, for example, in circuit-switched (CS) domain, and UE 110 may be identified by a SAE Temporary Mobile Subscriber Identity (S-TMSI) or International Mobile Subscriber Identity (IMSI). UE 110 may transmit a RA preamble (e.g., message 1) to network node 120. Upon receiving the RA preamble from UE 110, network node 120 may transmit a RAR to UE 110. Upon receiving the RAR from network node 120, UE 110 may transmit an extended service request to network node 120. The above pertains to the portion labeled as “situation 1” in FIG. 3.

In an event that no RAR has been received from network node 120 after UE 110 has transmitted a number of RA preambles to network node 120 (e.g., up to a threshold number of times), UE 110 may conduct or otherwise initiate a reestablishment procedure in response to not receiving any RAR from network node 120 after transmitting a number of RA preambles to network node 120. Upon successful reestablishment, UE 110 and network node 120 may be considered to be in synch in connected mode. However, as indicated in dotted-lined blocks, the reestablishment procedure may fail in an event that network node 120 continues to consider UE 110 to be in an idle state and thus may not respond to RA preambles from UE 110. In such cases UE 110 may return to idle state and may start synchronization again with network node 120. The above pertains to the portion labeled as “situation 2” in FIG. 3.

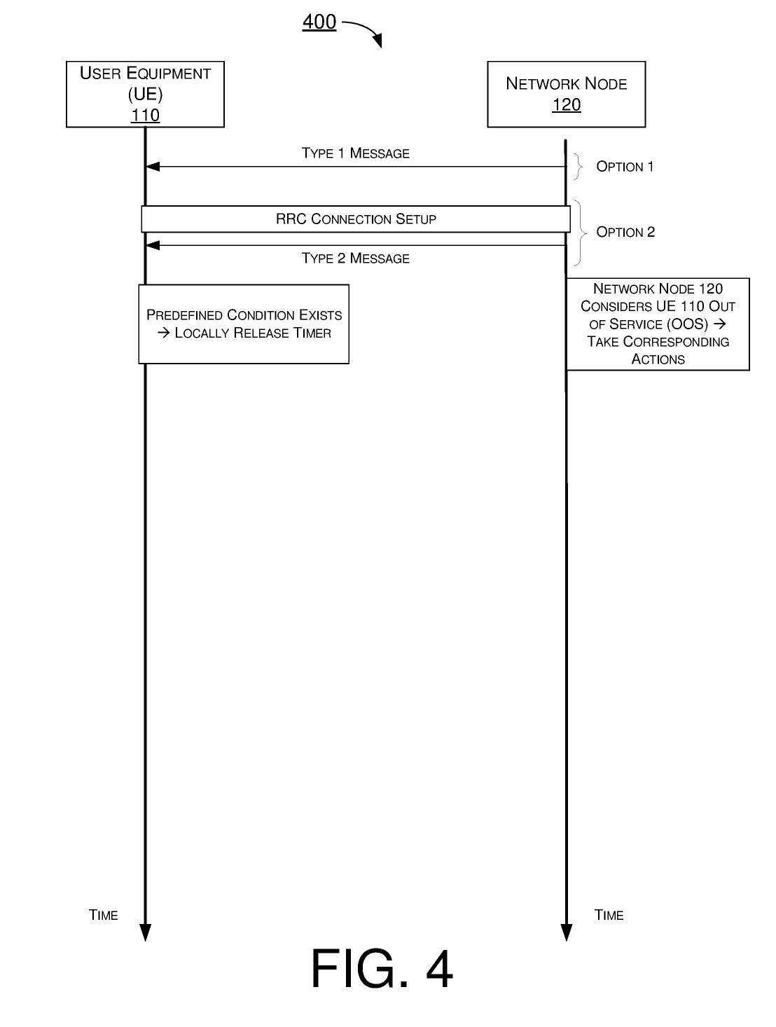

FIG. 4 illustrates an example scenario 400 under schemes in accordance with implementations of the present disclosure. Scenario 400 involves a UE 110 and a network node 120, which may be part of a wireless network (e.g., a LTE network, a LTE-Advanced network or a LTE-Advanced Pro network). The network, via network node 120, may provide UE 110 a configurable timer to detect whether UE 110 may be out of synchronization (out-of-sync) with the network. As shown in FIG. 4, in a first option (option 1), a first value (e.g., Tstate_async_detect) representative of a duration of a detection timer may be transmitted from network node 120 to UE 110 via a first type of message (type 1 message). The type 1 message may be broadcast in system information via, for example, a broadcast message transmitted to all UE's in communication with network node 120, including UE 110. Also shown in FIG. 4, in a second option (option 2), the first value representative of the duration of the detection timer may be transmitted from network node 120 to UE 110 via a second type of message (type 2 message). To transmit the first value to UE 110, network node 120 may set up a RRC connection with UE 110 and transmit the type 2 message which may be, for example, a dedicated signaling specific or otherwise dedicated for UE 110 (and optionally one or more other UE's). Either or both of option 1 and option 2 may be utilized.

At the UE end, in an event that a predefined condition exists, UE 110 may locally release the timer. The predefined condition may include, for example, (1) UE 110 has no DL user data, UL user data or signaling data for more than the duration of the detection timer, as represented by the first value; and (2) UE 110 is in a connected mode and that RRC connection is not released. At the network end, having not received any communication from UE 110, network node 120 may consider UE 110 to be out of service (00S). Consequently, network node 120 may release UE context for UE 110 and may also switch UE state of UE 110 to RRC idle. Moreover, UE 110 may return to idle state

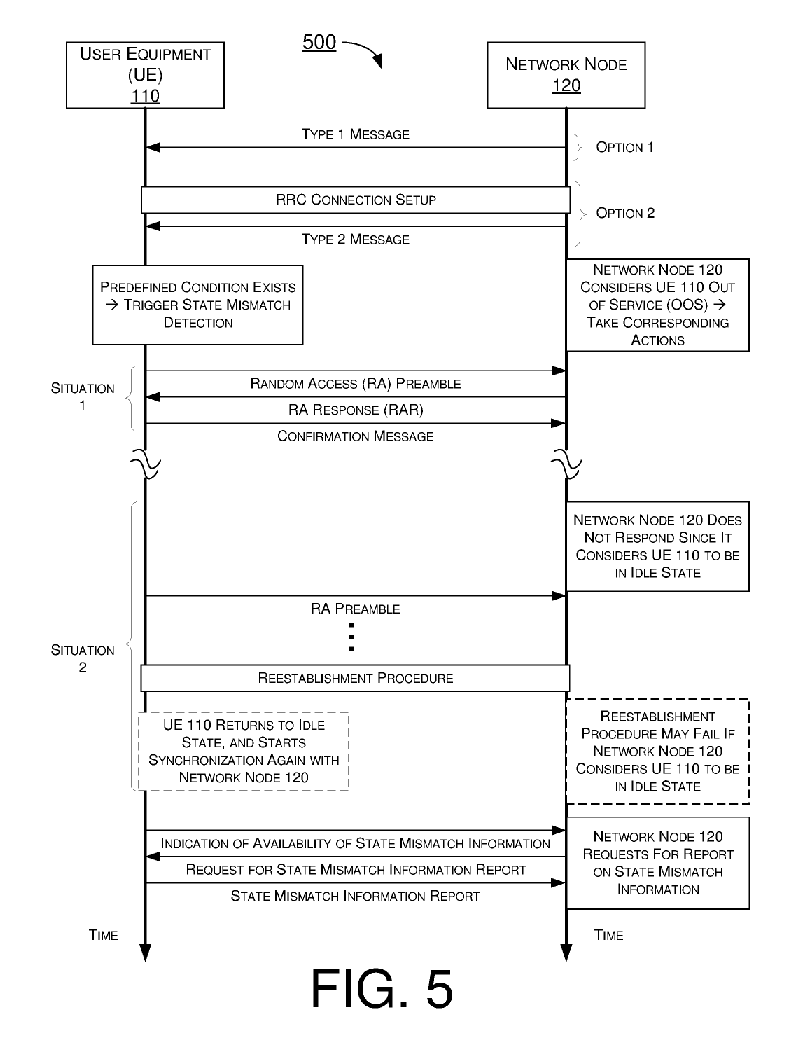

FIG. 5 illustrates an example scenario 500 under schemes in accordance with implementations of the present disclosure. Scenario 500 involves a UE 110 and a network node 120, which may be part of a wireless network (e.g., a LTE network, a LTE-Advanced network or a LTE-Advanced Pro network). The network, via network node 120, may provide UE 110 a configurable timer to detect whether UE 110 may be out of synchronization (out-of-sync) with the network. As shown in FIG. 5, in a first option (option 1), a first value (e.g., Tstate_async_detect) representative of a duration of a detection timer may be transmitted from network node 120 to UE 110 via a first type of message (type 1 message). The type 1 message may be broadcast in system information via, for example, a broadcast message transmitted to all UE's in communication with network node 120, including UE 110. Also shown in FIG. 5, in a second option (option 2), the first value representative of the duration of the detection timer may be transmitted from network node 120 to UE 110 via a second type of message (type 2 message). To transmit the first value to UE 110, network node 120 may set up a RRC connection with UE 110 and transmit the type 2 message which may be, for example, a dedicated signaling specific or otherwise dedicated for UE 110 (and optionally one or more other UE's). Either or both of option 1 and option 2 may be utilized.

At the UE end, in an event that a predefined condition exists, UE 110 may trigger a state mismatch detection to detect and determine whether there is a state mismatch between UE 110 and the network (as represented by network node 120). The predefined condition may include, for example, (1) UE 110 has no DL user data, UL user data or signaling data for more than the duration of the detection timer, as represented by the first value; and (2) UE 110 is in a connected mode and that RRC connection is not released. At the network end, having not received any communication from UE 110, network node 120 may consider UE 110 to be out of service (00S). Consequently, network node 120 may release UE context for UE 110 and may also switch UE state of UE 110 to RRC idle.

As part of the state mismatch detection, UE 110 may transmit a random access (RA) preamble (e.g., message 1) to network node 120. Upon receiving the RA preamble from UE 110, network node 120 may transmit a RA response (RAR) to UE 110. Upon receiving the RAR from network node 120, UE 110 may transmit a confirmation message to network node 120 to indicate that UE 110 is in a connected mode. The message may be, for example, a UE state synchronized message. The above pertains to the portion labeled as “situation 1” in FIG. 5.

In an event that no RAR has been received from network node 120 after UE 110 has transmitted a number of RA preambles to network node 120 (e.g., up to a threshold number of times), UE 110 may conduct or otherwise initiate a reestablishment procedure in response to not receiving any RAR from network node 120 after transmitting a number of RA preambles to network node 120. Upon successful reestablishment, UE 110 and network node 120 may be considered to be in synch in connected mode. However, as indicated in dotted-lined blocks, the reestablishment procedure may fail in an event that network node 120 continues to consider UE 110 to be in an idle state and thus may not respond to RA preambles from UE 110. In such cases UE 110 may return to idle state and may start synchronization again with network node 120. The above pertains to the portion labeled as “situation 2” in FIG. 5.

Additionally, in scenario 500, UE 110 may record information related to the state mismatch detection process. UE 110 may transmit a message to network node 120 to indicate the availability of the recorded information. Network node 120 may transmit a request message to UE 110 to request for a report on at least a portion of the recorded information. In response, UE 110 may transmit a report on at least a portion of the recorded information. The recorded information may include, for example and not limited to, Physical Cell Identification (PCI), EUTRA Absolute Radio Frequency Channel Number (EARFCN) and/or Global Cell Identification (GCI) of the state mismatched network node (e.g., network node 120), as well as the duration of the timer(s) (e.g., detection timer and/or paging timer) and whether the state mismatch detection process was triggered by paging or expiry of the detection timer and/or paging timer. Such information may be utilized by network node 120 (as well as the network as a whole) to performance improvement.

It is noteworthy that the first value representative of the duration of the detection timer (e.g., Tstate_async_detect) and the second value representative of the duration of the paging timer (e.g., Tstate_async_paging) may be different. For instance, the first value may be longer than the second value. In some implementations, the first value and the second value may be merged into a single value as the detection timer and the paging timer may be merged into a single timer. The use of timer(s) is for the purpose of detecting whether there is no UL/DL transmission (including signaling data for control and/or data plan) for a long time. When there is no UL/DL transmission for an amount of time equal to or longer than the duration of the timer(s), it may be assumed that state mismatch between UE 110 and network node 120 exists. With respect to the duration of the detection timer (e.g., Tstate_async_detect), UE 110 may transmit RA request(s), schedule request(s) or other RRC air message(s) to synchronize with network node 120 upon expiry of the detection timer or to locally release RRC connection. With respect to the duration of the paging timer (e.g., Tstate_async_paging), UE 110 may start to monitor UE paging occasions in connected mode upon expiry of the paging timer.

The first value and/or the second value, representative of the duration of the detection timer and the paging timer, respectively, may be provided by network node 120 to UE 110 (and other UE's) by including such value in system information block (SIB) when UE 110 is in idle mode, and this may be used for common UE's. For general UE's, the first value may have a normal range of value. For narrowband Internet-of-things (NB-IoT) and machine-type communications (MTC) UE's, a shorter value than general UE's may be used. The first value and/or the second value may also be provided by network node 120 to UE 110 (and other UE's) in a RRC reconfiguration message when UE 110 is in a connected mode. This may be used for dedicated UE. UE 110 may use the value from SIB if network node 120 does not assign the value for timer duration in RRC air message when UE 110 is in connected mode.

It is also noteworthy that, when state mismatch between a UE and a network occurs while the network has mobile-terminated call and/or data for the UE yet cannot reach the UE by paging message(s), the network may use PS-IMSI paging to request the UE to re-attach to the network. In an event that the UE does not respond to such PS-IMSI paging, the UE may be detached by the network and may not receive DL data until the next tracking area update (TAU) or attach. Moreover, reestablishment failure may trigger Non-Access Stratum (NAS) of the network to carry out a NAS recovery procedure (e.g., TAU). By triggering TAU, the UE may know whether the network still keeps it in a registered state.

### Illustrative Implementations

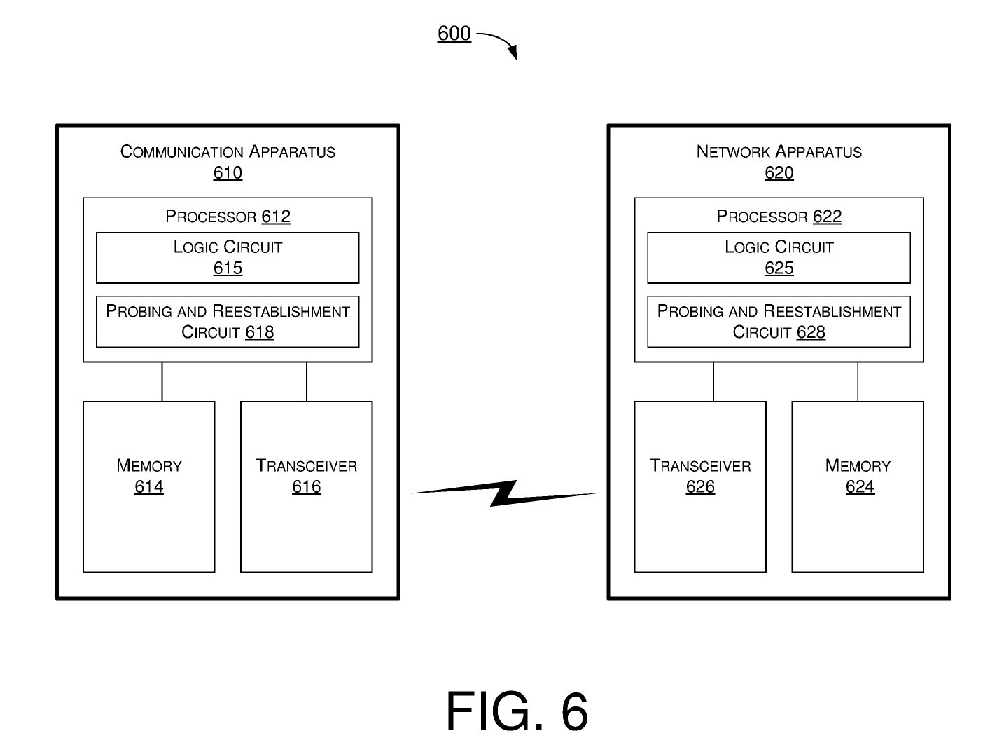

FIG. 6 illustrates an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to random access probing enhancement during state mismatch between a UE and a network, including scenarios 100, 200, 300, 400 and 500 described above as well as processes 700 and 800 described below.

Communication apparatus 610 may be a part of an electronic apparatus, which may be a UE such as a portable or mobile apparatus, a wearable apparatus, a wireless communication apparatus or a computing apparatus. For instance, communication apparatus 610 may be implemented in a smartphone, a smartwatch, a personal digital assistant, a digital camera, or a computing equipment such as a tablet computer, a laptop computer or a notebook computer. Alternatively, communication apparatus 610 may be implemented in the form of one or more integrated-circuit (IC) chips such as, for example and without limitation, one or more single-core processors, one or more multi-core processors, or one or more complex-instruction-set-computing (CISC) processors. In scenarios 100, 200, 300, 400 and 500, communication apparatus 610 may be implemented in or as UE 110. Communication apparatus 610 may include at least some of those components shown in FIG. 6 such as a processor 612, for example. Communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of an electronic apparatus, which may be a network node such as a base station, a router or a gateway. For instance, network apparatus 620 may be implemented in an eNodeB in a LTE, LTE-Advanced or LTE-Advanced Pro network. Alternatively, network apparatus 620 may be implemented in the form of one or more IC chips such as, for example and without limitation, one or more single-core processors, one or more multi-core processors, or one or more CISC processors. In scenarios 100, 200, 300, 400 and 500, network apparatus 610 may be implemented in or as network node 120. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including random access probing enhancement during state mismatch between a UE (e.g., communication apparatus 610) and a network (e.g., as represented by network apparatus 620) in accordance with various implementations of the present disclosure.

In some implementations, communication apparatus 612 may also include a transceiver 616 coupled to processor 612 and capable of wirelessly transmitting and receiving data. In some implementations, communication apparatus 610 may further include a memory 614 coupled to processor 612 and capable of being accessed by processor 612 and storing data therein. In some implementations, network apparatus 620 may also include a transceiver 626 coupled to processor 622 and capable of wirelessly transmitting and receiving data. In some implementations, network apparatus 620 may further include a memory 624 coupled to processor 622 and capable of being accessed by processor 622 and storing data therein. Accordingly, communication apparatus 610 and network apparatus 620 may wirelessly communicate with each other via transceiver 616 and transceiver 626, respectively. To aid better understanding, the following description of the operations, functionalities and capabilities of each of communication apparatus 610 and network apparatus 620 is provided in the context of a LTE/LTE-Advanced/LTE-Advanced Pro environment in which communication apparatus 610 is implemented in or as a UE and network apparatus 620 is implemented in or as a network node of a LTE/LTE-Advanced/LTE-Advanced Pro network.

The following description pertains to the operations, functionalities and capabilities of communication apparatus 610.

Processor 612 may include a logic circuit 615 and a probing and reestablishment circuit 618. Logic circuit 615 may determine whether a state mismatch exists between communication apparatus 610 and network apparatus 620. Probing and reestablishment circuit 618 may conduct a probing procedure responsive to a determination by logic circuit 615 that the state mismatch exists. In some implementations, in determining whether the state mismatch exists between communication apparatus 610 and network apparatus 620, logic circuit 615 may determine that the state mismatch exists between communication apparatus 610 and network apparatus 620 by performing a number of operations. For instance, logic circuit 615 may receive, via transceiver 616, a value representative of a timer duration from network apparatus 620. Logic circuit 615 may also determine that there is no communication with network apparatus 620 with respect to uplink user data, downlink user data and signaling data for more than the timer duration. Logic circuit 615 may further determine that communication apparatus 610 is in a connected mode. In some implementations, in receiving the value representative of the timer duration from network apparatus 620, logic circuit 615 may perform one or more of the following: (1) receiving, via transceiver 616, a first value representative of a duration of a detection timer in a first broadcast message from network apparatus 620; (2) receiving, via transceiver 616, the first value representative of the duration of the detection timer in a first messaged dedicated for communication apparatus 610 from network apparatus 620; (3) receiving, via transceiver 616, a second value representative of a duration of a paging timer in a second broadcast message from network apparatus 620; and (4) receiving, via transceiver 616, the second value representative of the duration of the paging timer in a second messaged dedicated for communication apparatus 610 from network apparatus 620. For example, the first value (e.g., Tstate_async_detect) may be a duration for the detection timer and upon the expiry of which control logic 615 may determine whether a predefined condition exists to trigger state mismatch detection in an event that it is determined that the predefined condition exists (e.g., no uplink user data, downlink user data or signaling data for more than the duration of the detection timer and RRC connection not released). As another example, the second value (e.g., Tstate_async_paging) may be a duration for the paging timer and upon the expiry of which control logic 615 may monitor paging occasions with communication apparatus 610 in connected mode.

In some implementations, in conducting the probing procedure, probing and reestablishment circuit 618 may trigger a state mismatch detection process by performing a number of operations. For instance, probing and reestablishment circuit 618 may transmit, via transceiver 616, at least one random access (RA) preamble to network apparatus 620. Probing and reestablishment circuit 618 may, responsive to receiving a RA response from network apparatus 620, transmit, via transceiver 616, a message to the network indicating that communication apparatus 610 is in a connected mode. Alternatively, probing and reestablishment circuit 618 may conduct a reestablishment procedure responsive to not receiving any RA response from network apparatus 620 after transmitting a number of RA preambles to network apparatus 620.

In some implementations, in conducting the probing procedure, probing and reestablishment circuit 618 may perform additional operations. For instance, probing and reestablishment circuit 618 may record information related to the state mismatch detection process in memory 614. Additionally, probing and reestablishment circuit 618 may transmit, via transceiver 616, to network apparatus 620 a message indicating availability of the recorded information. Moreover, probing and reestablishment circuit 618 may receive, via transceiver 616, from network apparatus 620 a request for a report on at least a portion of the recorded information. Furthermore, probing and reestablishment circuit 618 may transmit, via transceiver 616, to network apparatus 620 the at least a portion of the recorded information.

In some implementations, in conducting the probing procedure, probing and reestablishment circuit 618 may monitor paging occasions with communication apparatus 610 in a connected mode by performing a number of operations. For instance, probing and reestablishment circuit 618 may receive, via transceiver 616, a packet-switched (PS) paging message from network apparatus 620 after expiry of a paging timer. Additionally, probing and reestablishment circuit 618 may transmit, via transceiver 616, at least one RA preamble to network apparatus 620. Probing and reestablishment circuit 618 may, responsive to receiving a RA response from network apparatus 620, transmit, via transceiver 616, a message to the network indicating that communication apparatus 610 is in a connected mode. For example, a UE C-RNTI MAC CE may be transmitted to network apparatus 620. As another example, a UE state synchronized message may be transmitted to network apparatus 620. Alternatively, probing and reestablishment circuit 618 may conduct a reestablishment procedure responsive to not receiving any RA response from network apparatus 620 after transmitting a number of RA preambles to network apparatus 620 (e.g., up to a threshold number of times).

In some implementations, in conducting the probing procedure, probing and reestablishment circuit 618 may monitor paging occasions with communication apparatus 610 in a connected mode by performing a number of operations. For instance, probing and reestablishment circuit 618 may receive, via transceiver 616, a circuit-switched (CS) paging message from network apparatus 620 after expiry of a paging timer. Additionally, probing and reestablishment circuit 618 may transmit, via transceiver 616, a layer-3 extended service request to network apparatus 620 responsive to receiving the CS paging message. Moreover, probing and reestablishment circuit 618 may transmit, via transceiver 616, at least one RA preamble to network apparatus 620. Furthermore, probing and reestablishment circuit 618 may, responsive to receiving a RA response from network apparatus 620, transmit, via transceiver 616, a layer-3 extended service request to network apparatus 620 responsive to receiving the CS paging message. For example, a UE C-RNTI MAC CE may be transmitted to network apparatus 620. As another example, a UE state synchronized message may be transmitted to network apparatus 620. Alternatively, probing and reestablishment circuit 618 may conduct a reestablishment procedure responsive to not receiving any RA response from network apparatus 620 after transmitting a number of RA preambles to network apparatus 620.

In some implementations, in determining whether the state mismatch exists between communication apparatus 610 and network apparatus 620, logic circuit 615 may receive, via transceiver 616, a value representative of a duration of a timer from network apparatus 620. Logic circuit 615 may also determine that there is no communication with network apparatus 620 with respect to uplink user data, downlink user data and signaling data for more than the timer duration. Logic circuit 615 may further determine that communication apparatus 610 is in a connected mode. In some implementation, in conducting the probing procedure, probing and reestablishment circuit 618 may locally release the timer.

The following description pertains to the operations, functionalities and capabilities of network apparatus 620.

Processor 622 may include a logic circuit 625 and a probing and reestablishment circuit 628. Logic circuit 625 may transmit, via transceiver 626, a value representative of a timer duration to communication apparatus 610. Probing and reestablishment circuit 628 may participate in a probing procedure with communication apparatus 610 responsive to either of the following: (1) receiving a RA preamble from communication apparatus 610; or (2) logic circuit 625 determining that there is data or a mobile-terminated call for communication apparatus 610. In some implementations, in transmitting the value representative of the timer duration to communication apparatus 610, logic circuit 625 may perform one or more of the following: (1) transmitting, via transceiver 626, a first value representative of a duration of a detection timer in a first broadcast message to communication apparatus 610; (2) transmitting, via transceiver 626, the first value representative of the duration of the detection timer in a first messaged dedicated for communication apparatus 610 to communication apparatus 610; (3) transmitting, via transceiver 626, a second value representative of a duration of a paging timer in a second broadcast message to communication apparatus 610; and (4) transmitting, via transceiver 626, the second value representative of the duration of the paging timer in a second messaged dedicated for communication apparatus 610 to communication apparatus 610. For example, the first value (e.g., Tstate_async_detect) may be a duration for the detection timer and upon the expiry of which communication apparatus 610 may determine whether a predefined condition exists to trigger state mismatch detection in an event that it is determined that the predefined condition exists (e.g., no uplink user data, downlink user data or signaling data for more than the duration of the detection timer and RRC connection not released). As another example, the second value (e.g., Tstate_async_paging) may be a duration for the paging timer and upon the expiry of which communication apparatus 610 may monitor paging occasions with communication apparatus 610 in connected mode.

In some implementations, in participating in the probing procedure with communication apparatus 610, probing and reestablishment circuit 628 may perform a number of operations. For instance, probing and reestablishment circuit 628 may receive, via transceiver 626, a RA preamble from communication apparatus 610. Additionally, probing and reestablishment circuit 628 may transmit, via transceiver 626, a RA response to communication apparatus 610 responsive to receiving the RA preamble. Moreover, probing and reestablishment circuit 628 may receive, via transceiver 626, a message from communication apparatus 610 indicating that communication apparatus 610 is in a connected mode. For example, a UE C-RNTI MAC CE may be received from communication apparatus 610. As another example, a UE state synchronized message may be received from communication apparatus 610.

In some implementations, in participating in the probing procedure with communication apparatus 610, probing and reestablishment circuit 628 may perform a number of operations. For instance, probing and reestablishment circuit 628 may participate in a reestablishment procedure with communication apparatus 610. Additionally, probing and reestablishment circuit 628 may receive, via transceiver 626, from communication apparatus 610 a message indicating availability of information recorded by communication apparatus 610 related to a state mismatch detection process. Moreover, probing and reestablishment circuit 628 may transmit, via transceiver 626, a request for a report on at least a portion of the recorded information. Furthermore, probing and reestablishment circuit 628 may receive, via transceiver 626, from communication apparatus 610 the at least a portion of the recorded information.

In some implementations, in participating in the probing procedure with communication apparatus 610, probing and reestablishment circuit 628 may perform a number of operations. For instance, probing and reestablishment circuit 628 may transmit, via transceiver 626, a PS paging message to communication apparatus 610 after expiry of a paging timer. Additionally, probing and reestablishment circuit 628 may receive, via transceiver 626, a RA preamble from communication apparatus 610. Moreover, probing and reestablishment circuit 628 may transmit, via transceiver 626, a RA response to communication apparatus 610 responsive to receiving the RA preamble. Furthermore, probing and reestablishment circuit 628 may receive, via transceiver 626, a message from communication apparatus 610 indicating that communication apparatus 610 is in a connected mode. For example, a UE C-RNTI MAC CE may be received from communication apparatus 610. As another example, a UE state synchronized message may be received from communication apparatus 610.

In some implementations, in participating in the probing procedure with communication apparatus 610, probing and reestablishment circuit 628 may perform a number of operations. For instance, probing and reestablishment circuit 628 may transmit, via transceiver 626, a CS paging message to communication apparatus 610 after expiry of a paging timer. Additionally, probing and reestablishment circuit 628 may receive, via transceiver 626, a RA preamble from communication apparatus 610. Moreover, probing and reestablishment circuit 628 may transmit, via transceiver 626, a RA response to communication apparatus 610 responsive to receiving the RA preamble. Furthermore, probing and reestablishment circuit 628 may receive, via transceiver 626, a layer-3 extended service request from communication apparatus 610. For example, a UE C-RNTI MAC CE may be received from communication apparatus 610. As another example, a UE state synchronized message may be received from communication apparatus 610.

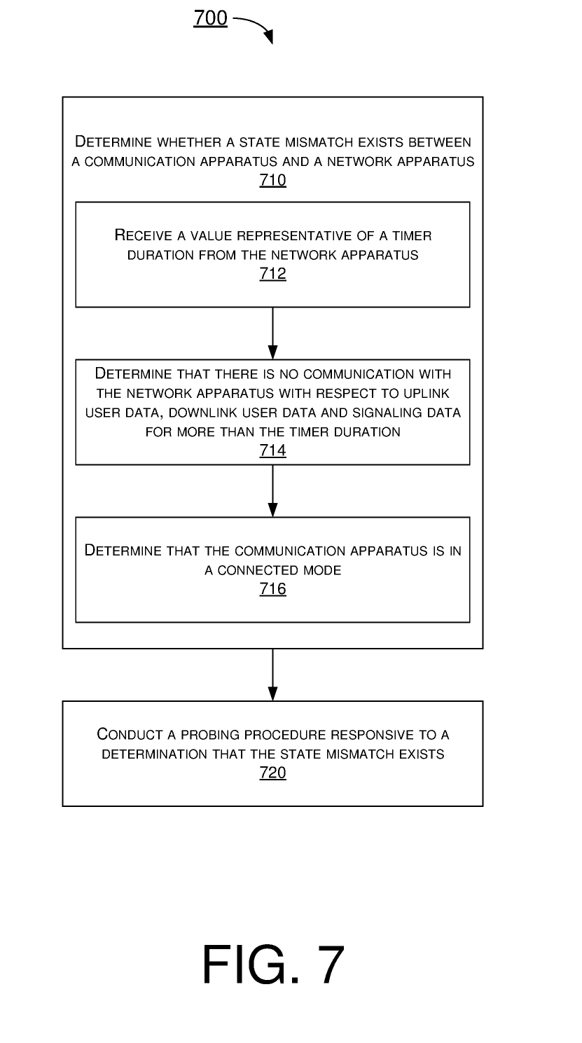

FIG. 7 illustrates an example process 700 in accordance with an implementation of the present disclosure. Process 700 may be an example implementation of one, some or all of scenarios 100, 200, 300, 400 and 500, whether partially or completely, with respect to random access probing enhancement during state mismatch in accordance with the present disclosure. Process 700 may represent an aspect of implementation of features of communication apparatus 610. Process 700 may include one or more operations, actions, or functions as illustrated by one or more of blocks 710 and 720 as well as sub-blocks 712, 714 and 716. Although illustrated as discrete blocks, various blocks of process 700 may be divided into additional blocks, combined into fewer blocks, or eliminated, depending on the desired implementation. Moreover, the blocks of process 700 may executed in the order shown in FIG. 7 or, alternatively, in a different order. Process 700 may be implemented by communication apparatus 610 or any suitable UE. Solely for illustrative purposes and without limitation, process 700 is described below in the context of communication apparatus 610. Process 700 may begin at block 710.

At 710, process 700 may involve communication apparatus 610 determining whether a state mismatch exists between the communication apparatus and a network apparatus. In some implementations, in determining whether the state mismatch exists between the communication apparatus and the network apparatus, process 700 may involve communication apparatus 610 determining that the state mismatch exists between communication apparatus 610 and the network apparatus by performing operations such as those represented in sub-blocks 712, 714 and 716. At 712, process 700 may involve communication apparatus 610 receiving a value representative of a timer duration from the network apparatus. Process 700 may proceed from 712 to 714. At 714, process 700 may involve communication apparatus 610 determining that there is no communication with network apparatus 620 with respect to uplink user data, downlink user data and signaling data for more than the timer duration. Process 700 may proceed from 714 to 716. At 716, process 700 may involve communication apparatus 610 determining that communication apparatus 610 is in a connected mode. Process 700 may proceed from 710 to 720.

At 720, process 700 may involve communication apparatus 610 conducting a probing procedure responsive to a determination that the state mismatch exists.

In some implementations, in receiving the value representative of the timer duration from network apparatus 620, process 700 may involve communication apparatus 610 performing one or more of the following: (1) receiving a first value representative of a duration of a detection timer in a first broadcast message from network apparatus 620; (2) receiving the first value representative of the duration of the detection timer in a first messaged dedicated for communication apparatus 610 from network apparatus 620; (3) receiving a second value representative of a duration of a paging timer in a second broadcast message from network apparatus 620; and (4) receiving the second value representative of the duration of the paging timer in a second messaged dedicated for communication apparatus 610 from network apparatus 620.

In some implementations, in conducting the probing procedure, process 700 may involve communication apparatus 610 triggering a state mismatch detection process by performing: (1) transmitting at least one RA preamble to network apparatus 620; and (2) performing either of: (a) responsive to receiving a RA response from network apparatus 620, transmitting a message to the network indicating that communication apparatus 610 is in a connected mode; or (b) conducting a reestablishment procedure responsive to not receiving any RA response from network apparatus 620 after transmitting a number of RA preambles to network apparatus 620.

In some implementations, in conducting the probing procedure, process 700 may further involve communication apparatus 610 performing additional operations. For instance, process 700 may involve communication apparatus 610 recording information related to the state mismatch detection process. Additionally, process 700 may involve communication apparatus 610 transmitting to network apparatus 620 a message indicating availability of the recorded information. Moreover, process 700 may involve communication apparatus 610 receiving from network apparatus 620 a request for a report on at least a portion of the recorded information. Furthermore, process 700 may involve communication apparatus 610 transmitting to network apparatus 620 the at least a portion of the recorded information.

In some implementations, in conducting the probing procedure, process 700 may involve communication apparatus 610 monitoring paging occasions in a connected mode by performing the following: (1) receiving a PS paging message from network apparatus 620 after expiry of a paging timer; (2) transmitting at least one RA preamble to network apparatus 620; and (3) performing either of: (a) responsive to receiving a RA response from network apparatus 620, transmitting a message to the network indicating that communication apparatus 610 is in a connected mode; or (b) conducting a reestablishment procedure responsive to not receiving any RA response from network apparatus 620 after transmitting a number of RA preambles to network apparatus 620.

In some implementations, in conducting the probing procedure, process 700 may involve communication apparatus 610 monitoring paging occasions in a connected mode by performing the following: (1) receiving a CS paging message from network apparatus 620 after expiry of a paging timer; (2) transmitting a layer-3 extended service request to network apparatus 620 responsive to receiving the CS paging message; (3) transmitting at least one RA preamble to network apparatus 620; and (4) performing either of: (a) responsive to receiving a RA response from network apparatus 620, transmitting a message to the network indicating that communication apparatus 610 is in the connected mode; or (b) conducting a reestablishment procedure responsive to not receiving any RA response from network apparatus 620 after transmitting a number of RA preambles to network apparatus 620.

In some implementations, in determining whether the state mismatch exists between communication apparatus 610 and network apparatus 620, process 700 may involve communication apparatus 610 receiving a value representative of a duration of a timer from network apparatus 620. Additionally, process 700 may involve communication apparatus 610 determining that there is no communication with network apparatus 620 with respect to uplink user data, downlink user data and signaling data for more than the timer duration. Moreover, process 700 may involve communication apparatus 610 determining that communication apparatus 610 is in a connected mode. In some implementations, in conducting the probing procedure, process 700 may involve communication apparatus 610 locally releasing the timer.

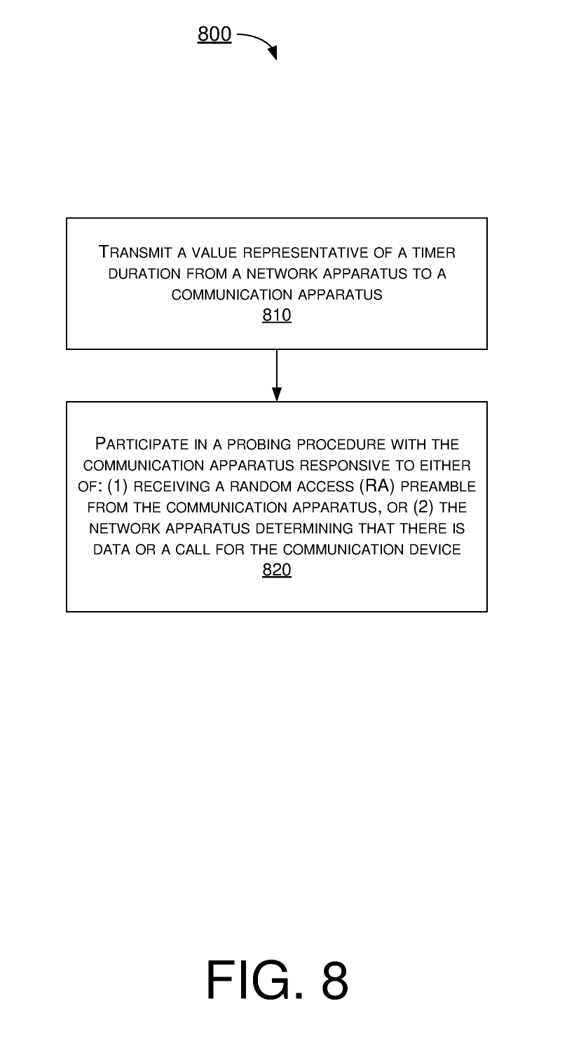

FIG. 8 illustrates an example process 800 in accordance with an implementation of the present disclosure. Process 800 may be an example implementation of one, some or all of scenarios 100, 200, 300, 400 and 500, whether partially or completely, with respect to random access probing enhancement during state mismatch in accordance with the present disclosure. Process 800 may represent an aspect of implementation of features of network apparatus 620. Process 800 may include one or more operations, actions, or functions as illustrated by one or more of blocks 810 and 820. Although illustrated as discrete blocks, various blocks of process 800 may be divided into additional blocks, combined into fewer blocks, or eliminated, depending on the desired implementation. Moreover, the blocks of process 800 may executed in the order shown in FIG. 8 or, alternatively, in a different order. Process 800 may be implemented by network apparatus 620 or any suitable network node. Solely for illustrative purposes and without limitation, process 800 is described below in the context of network apparatus 620. Process 800 may begin at block 810.

At 810, process 800 may involve network apparatus 620 transmitting a value representative of a timer duration to a communication apparatus. Process 800 may proceed from 810 to 820.

At 820, process 800 may involve network apparatus 620 participating in a probing procedure with communication apparatus 610 responsive to either of the following: (1) receiving a RA preamble from communication apparatus 610; or (2) the network apparatus 620 determining that there is data or a mobile-terminated call for communication apparatus 610.

In some implementations, in transmitting the value representative of the timer duration to communication apparatus 610, process 800 may involve network apparatus 620 performing one or more of the following: (1) transmitting a first value representative of a duration of a detection timer in a first broadcast message to communication apparatus 610; (2) transmitting the first value representative of the duration of the detection timer in a first messaged dedicated for communication apparatus 610 to communication apparatus 610; (3) transmitting a second value representative of a duration of a paging timer in a second broadcast message to communication apparatus 610; and (4) transmitting the second value representative of the duration of the paging timer in a second messaged dedicated for communication apparatus 610 to communication apparatus 610.

In some implementations, in participating in the probing procedure with communication apparatus 610, process 800 may involve network apparatus 620 receiving a RA preamble from communication apparatus 610. Additionally, process 800 may involve network apparatus 620 transmitting a RA response to communication apparatus 610 responsive to receiving the RA preamble. Moreover, process 800 may involve network apparatus 620 receiving a message from communication apparatus 610 indicating that communication apparatus 610 is in a connected mode.

In some implementations, in participating in the probing procedure with communication apparatus 610, process 800 may involve network apparatus 620 participating in a reestablishment procedure with communication apparatus 610. Additionally, process 800 may involve network apparatus 620 receiving from communication apparatus 610 a message indicating availability of information recorded by communication apparatus 610 related to a state mismatch detection process. Moreover, process 800 may involve network apparatus 620 transmitting a request for a report on at least a portion of the recorded information. Furthermore, process 800 may involve network apparatus 620 receiving from communication apparatus 610 the at least a portion of the recorded information.

In some implementations, in participating in the probing procedure with communication apparatus 610, process 800 may involve network apparatus 620 transmitting a PS paging message to communication apparatus 610 after expiry of a paging timer. Additionally, process 800 may involve network apparatus 620 receiving a RA preamble from communication apparatus 610. Moreover, process 800 may involve network apparatus 620 transmitting a RA response to communication apparatus 610 responsive to receiving the RA preamble. Furthermore, process 800 may involve network apparatus 620 receiving a message from communication apparatus 610 indicating that communication apparatus 610 is in a connected mode.

In some implementations, in participating in the probing procedure with communication apparatus 610, process 800 may involve network apparatus 620 transmitting a CS paging to communication apparatus 610 after expiry of a paging timer. Additionally, process 800 may involve network apparatus 620 receiving a RA preamble from communication apparatus 610. Moreover, process 800 may involve network apparatus 620 transmitting a RA response to communication apparatus 610 responsive to receiving the RA preamble. Furthermore, process 800 may involve network apparatus 620 receiving a message from communication apparatus 610 indicating that communication apparatus 610 is in a connected mode.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a communication apparatus, whether a state mismatch exists between the communication apparatus and a network apparatus; and
conducting, by the communication apparatus, a probing procedure responsive to a determination that the state mismatch exists.

2. The method of claim 1, wherein the determining of whether the state mismatch exists between the communication apparatus and the network apparatus comprises determining that the state mismatch exists between the communication apparatus and the network apparatus by:
receiving a value representative of a timer duration from the network apparatus;
determining that there is no communication with the network apparatus with respect to uplink user data, downlink user data and signaling data for more than the timer duration; and
determining that the communication apparatus is in a connected mode.

3. The method of claim 2, wherein the receiving of the value representative of the timer duration from the network apparatus comprises performing one or more of:
receiving a first value representative of a duration of a detection timer in a first broadcast message from the network apparatus;
receiving the first value representative of the duration of the detection timer in a first messaged dedicated for the communication apparatus from the network apparatus;
receiving a second value representative of a duration of a paging timer in a second broadcast message from the network apparatus; and
receiving the second value representative of the duration of the paging timer in a second messaged dedicated for the communication apparatus from the network apparatus.

4. The method of claim 1, wherein the conducting of the probing procedure comprises triggering a state mismatch detection process by:
transmitting at least one random access (RA) preamble to the network apparatus; and
performing either of:
responsive to receiving a RA response from the network apparatus, transmitting a message to the network indicating that the communication apparatus is in a connected mode; or
conducting a reestablishment procedure responsive to not receiving any RA response from the network apparatus after transmitting a number of RA preambles to the network apparatus.

5. The method of claim 4, wherein the conducting of the probing procedure further comprises:
recording information related to the state mismatch detection process;
transmitting to the network apparatus a message indicating availability of the recorded information;
receiving from the network apparatus a request for a report on at least a portion of the recorded information; and
transmitting to the network apparatus the at least a portion of the recorded information.

6. The method of claim 1, wherein the conducting of the probing procedure comprises monitoring paging occasions in a connected mode by:
receiving a packet-switched (PS) paging message from the network apparatus after expiry of a paging timer;
transmitting at least one random access (RA) preamble to the network apparatus; and
performing either of:
responsive to receiving a RA response from the network apparatus, transmitting a message to the network indicating that the communication apparatus is in a connected mode; or
conducting a reestablishment procedure responsive to not receiving any RA response from the network apparatus after transmitting a number of RA preambles to the network apparatus.

7. The method of claim 1, wherein the conducting of the probing procedure comprises monitoring paging occasions in a connected mode by:
receiving a circuit-switched (CS) paging message from the network apparatus after expiry of a paging timer;
transmitting a layer-3 extended service request to the network apparatus responsive to receiving the CS paging message;
transmitting at least one random access (RA) preamble to the network apparatus; and
performing either of:
responsive to receiving a RA response from the network apparatus, transmitting a message to the network indicating that the communication apparatus is in the connected mode; or
conducting a reestablishment procedure responsive to not receiving any RA response from the network apparatus after transmitting a number of RA preambles to the network apparatus.

8. The method of claim 1, wherein:
the determining of whether the state mismatch exists between the communication apparatus and the network apparatus comprises:
receiving a value representative of a duration of a timer from the network apparatus;
determining that there is no communication with the network apparatus with respect to uplink user data, downlink user data and signaling data for more than the timer duration; and
determining that the communication apparatus is in a connected mode; and
the conducting of the probing procedure comprises locally releasing the timer.

9. A method, comprising:
transmitting, by a network apparatus, a value representative of a timer duration to a communication apparatus;
participating, by the network apparatus, in a probing procedure with the communication apparatus responsive to either of:
receiving a random access (RA) preamble from the communication apparatus; or
determining that there is data or a mobile-terminated call for the communication apparatus.

10. The method of claim 9, wherein the transmitting of the value representative of the timer duration to the communication apparatus comprises performing one or more of:
transmitting a first value representative of a duration of a detection timer in a first broadcast message to the communication apparatus;
transmitting the first value representative of the duration of the detection timer in a first messaged dedicated for the communication apparatus to the communication apparatus;
transmitting a second value representative of a duration of a paging timer in a second broadcast message to the communication apparatus; and
transmitting the second value representative of the duration of the paging timer in a second messaged dedicated for the communication apparatus to the communication apparatus.

11. The method of claim 9, wherein the participating in the probing procedure with the communication apparatus comprises:
receiving a random access (RA) preamble from the communication apparatus;
transmitting a RA response to the communication apparatus responsive to receiving the RA preamble; and
receiving a message from the communication apparatus indicating that the communication apparatus is in a connected mode.

12. The method of claim 9, wherein the participating in the probing procedure with the communication apparatus comprises:
transmitting a packet-switched (PS) paging message to the communication apparatus after expiry of a paging timer;
receiving a random access (RA) preamble from the communication apparatus;
transmitting a RA response to the communication apparatus responsive to receiving the RA preamble; and
receiving a message from the communication apparatus indicating that the communication apparatus is in a connected mode.

13. The method of claim 9, wherein the participating in the probing procedure with the communication apparatus comprises:
transmitting a circuit-switched (CS) paging to the communication apparatus after expiry of a paging timer;
receiving a random access (RA) preamble from the communication apparatus;
transmitting a RA response to the communication apparatus responsive to receiving the RA preamble; and
receiving an extended service request from the communication apparatus indicating that the communication apparatus is in a connected mode.

14. A communication apparatus, comprising:
a transceiver capable of wirelessly communicating with a network apparatus; and
a processor capable of determining whether a state mismatch exists between the communication apparatus and the network apparatus, the processor also capable of conducting a probing procedure responsive to a determination that the state mismatch exists,
wherein, in determining whether the state mismatch exists between the communication apparatus and the network apparatus, the processor determines that the state mismatch exists between the communication apparatus and the network apparatus by performing operations comprising:
receiving, via the transceiver, a value representative of a timer duration from the network apparatus;
determining that there is no communication with the network apparatus with respect to uplink user data, downlink user data and signaling data for more than the timer duration; and
determining that the communication apparatus is in a connected mode.

15. The apparatus of claim 14, wherein, in conducting the probing procedure, the processor triggers a state mismatch detection process by:
transmitting, via the transceiver, at least one random access (RA) preamble to the network apparatus; and
performing either of:
responsive to receiving a RA response from the network apparatus, transmitting, via the transceiver, a message to the network indicating that the communication apparatus is in a connected mode; or
conducting a reestablishment procedure responsive to not receiving any RA response from the network apparatus after transmitting a number of RA preambles to the network apparatus.

16. The apparatus of claim 15, wherein, in conducting the probing procedure, the processor further performs operations comprising:
recording information related to the state mismatch detection process;
transmitting, via the transceiver, to the network apparatus a message indicating availability of the recorded information;
receiving, via the transceiver, from the network apparatus a request for a report on at least a portion of the recorded information; and
transmitting, via the transceiver, to the network apparatus the at least a portion of the recorded information.

17. The apparatus of claim 14, wherein, in conducting the probing procedure, the processor monitors paging occasions in a connected mode by receiving, via the transceiver, a packet-switched (PS) paging message or a circuit-switched (CS) paging message from the network apparatus after expiry of a paging timer.

18. The apparatus of claim 14, wherein:
in determining whether the state mismatch exists between the communication apparatus and the network apparatus, the processor performs operations comprising:
receiving, via the transceiver, a value representative of a duration of a timer from the network apparatus;
determining that there is no communication with the network apparatus with respect to uplink user data, downlink user data and signaling data for more than the timer duration; and
determining that the communication apparatus is in a connected mode; and
in conducting the probing procedure, the processor locally releases the timer.

19. A network apparatus, comprising:
a transceiver capable of wirelessly communicating with a communication apparatus; and
a processor capable of transmitting, via the transceiver, a value representative of a timer duration to a communication apparatus, the processor also capable of participating in a probing procedure with the communication apparatus responsive to either of:
receiving a random access (RA) preamble from the communication apparatus; or
determining that there is data or a mobile-terminated call for the communication apparatus.

20. The apparatus of claim 19, wherein, in participating in the probing procedure with the communication apparatus, the processor performs operations comprising:
receiving, via the transceiver, a random access (RA) preamble from the communication apparatus;
transmitting, via the transceiver, a RA response to the communication apparatus responsive to receiving the RA preamble; and
receiving, via the transceiver, a message from the communication apparatus indicating that the communication apparatus is in a connected mode.
